(19) United States
(12) Patent Application Publication
(10) Pub. No.: US 2008/0189722 A1
(43) Pub. Date: Aug. 7, 2008

(54) Generic Device Driver Replacement

(75) Inventors: Eugene S. Lin, Seattle, WA (US); Jason T. Cobb, Sammamish, WA (US); James G. Cavalaris, Kirkland, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/670,745

(22) Filed: Feb. 2, 2007

(51) Int. Cl. G06F 13/00

(52) U.S. Cl. 719/321

(57) ABSTRACT

Some device drivers support the “least common denominator” features of a device, such as a generic VGA driver which does not provide access to higher resolution or other features supported by a video card. It may be difficult for computer users to know when an enhanced driver is available. A method is provided to notify a user that a device driver on the user's system is generic and that an enhanced device driver is available.

### TECHNICAL FIELD

This description relates generally to installing drivers on computer systems and more specifically to replacing generic drivers with enhanced drivers.

### BACKGROUND

Device drivers can have a large impact on the performance or capabilities of certain devices on a computer. Some device drivers support a “least common denominator” set of features for a broad class of devices. For example, a display driver may support only certain low-resolution modes based on an industry-standard specification such as VGA. MICROSOFT WINDOWS, for example, includes several such drivers, often called “generic drivers.” When a new device is installed, the operating system (OS) will automatically install a generic driver if it is compatible with the device and no better driver is available. For devices that support additional features above and beyond those supported by the generic driver, the generic driver may not provide a satisfactory user experience. There are often manufacturer-provided drivers are available on the web which will take advantage of features supported by a device, but the OS may not notify the user that such drivers are available.

### SUMMARY

The following presents a simplified summary of the disclosure in order to provide a basic understanding to the reader. This summary is not an extensive overview of the disclosure and it does not identify key/critical elements of the subject matter or delineate the scope of the claimed subject matter. Its sole purpose is to present some concepts disclosed herein in a simplified form as a prelude to the more detailed description that is presented later.

The present example provides a way for notifying a user that a solution, like an enhanced driver with better support for the user's device, is available. This solution may be available over the Internet, an intranet, or over a local area network, for example. When a device is installed and a generic driver is all that known about for the system, the OS may contact a server to check for availability of an enhanced driver. If there is an enhanced driver available, the user may be notified. Such an enhanced driver may be stored on a server on a local area network, on a server available via the Internet, on the target computer, or on a peer of the target computer that is available via a server-based network, a peer-to-peer network, the Internet, or the like. There may be more than one enhanced driver available, and the user notification may include various features available on different enhanced drivers. In at least one alternate implementation, an enhanced driver may be installed without notifying the user. If there are multiple enhanced drivers available, the selection of which driver is optimal to install may be based on additional information about the operating environment, including a version of the operating system, other software installed, indicators of how the computer is used (business or gaming, for example), which generic driver was installed, or the like.

Many of the attendant features may be more readily appreciated as the same becomes better understood by reference to the following detailed description considered in connection with the accompanying drawings.

### DESCRIPTION OF THE DRAWINGS

The present description may be better understood from the following detailed description read in light of the accompanying drawings, wherein:

FIG. 1 is a block diagram of an exemplary conventional computer network.

FIG. 2 is a block diagram of an example of a networked computing system operating environment in which the server contains a service capable of supporting notifying a user that an enhanced device driver is available.

FIG. 3 is a flowchart of an exemplary implementation for notifying a computer user that a generic device driver is in use and that an enhanced driver is available.

FIG. 4 is a flowchart of an exemplary implementation for automatically replacing a generic device driver with an enhanced driver.

FIG. 5 is a block diagram of a device driver.

FIG. 6 is a block diagram of a device driver with an identification method to indicate that it is a generic driver.

FIG. 7 is a block diagram of exemplary computer with a generic device driver with access to a process for replacing a generic device driver with an enhanced driver.

FIG. 8 is a block diagram of exemplary computer with an enhanced device driver after being updated by a process for replacing a generic device driver with an enhanced driver.

FIG. 9 is a block diagram which illustrates an exemplary computing environment in which the process for replacing a generic device driver with an enhanced driver may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

The examples below describe a process and a system for notifying a user that an enhanced device driver is available for the user's computer. Although the present examples are described and illustrated herein as being implemented in client PCs and a server with a hard drive system, the system described is provided as an example and not a limitation. The present examples are suitable for application in a variety of different types of variety of different types of computing processors in various computer systems.

The present example provides a way for a server to provide a device driver capable of providing additional functionality or a better user experience than a generic device driver currently installed on a user's system. Before describing the present example a conventional network will first be described.

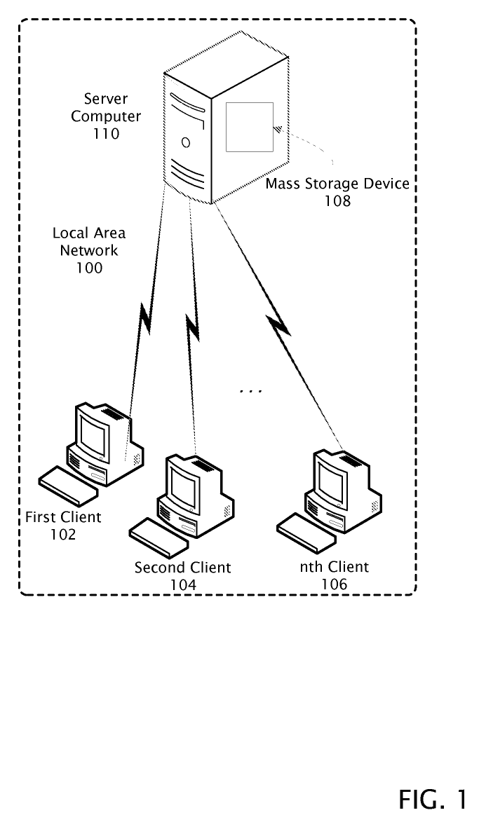

FIG. 1 is a block diagram of a conventional computer network. Such a system may not provide a method to notify a user of the availability of better device drivers for her computer. Local area network 100 may contain server computer 110, first client computer 102, second client computer 104, and nth client computer 106. Any number of client computers, as well as various hubs, switches, and other network devices may be utilized in such a conventional network.

The local area network 100 is configured to connect to any number of other local area networks, and such connections could be made a number of ways including, but not limited to, the internet, an intranet, satellite connections, or wireless connections, or any combination of the possible connections. The local area network 100 may also stand alone and not be connected to any other local area networks or wide area networks. A number of other components such as routers, switches and the like may also be present to facilitate networking.

Server computer 110 is conventionally constructed and includes a mass storage device 108. Such a mass storage system can include individual hard drives or networked hard drives such as RAID drives or the like.

Client computers 102, 104, and 106 are conventionally constructed and may be initialized by conventional methods. For example the client computers may be conventional PCs, computers, processors, microcontrollers or the like.

The following figure and description provides an example of a network capable of supporting the process of notifying a user that an enhanced device driver is available.

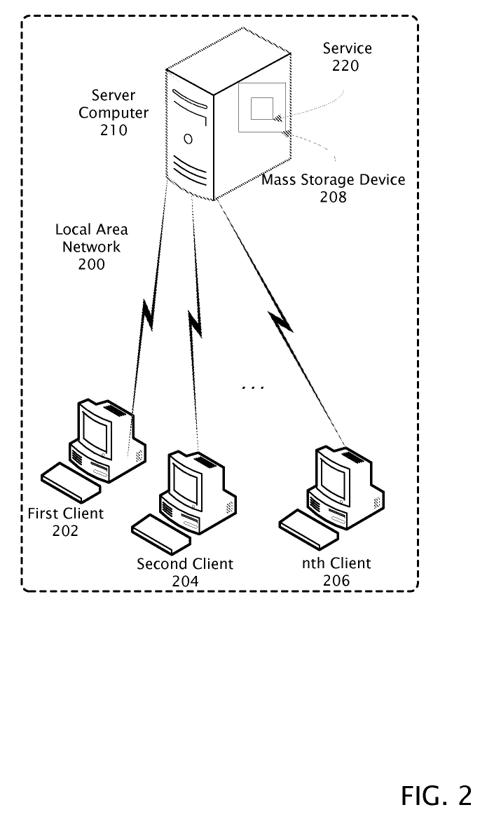

FIG. 2 is a block diagram of an example of a networked computing system operating environment in which the server contains a service capable of supporting notifying a user that an enhanced device driver is available. In the following discussion, continuing reference may be made to elements and/or reference numerals contained in previous figures.

Local area network 200 includes server computer 210, client computers 202, 204, and 206. The local area network 200 could also include a plurality of servers, hubs, switches, wireless access points, and other network devices, as well as any number of server and client computers.

Server computer 210 may include a service 220 disposed on a mass storage device 208. Such a mass storage system can include individual hard drives or networked hard drives such as RAID (Redundant Array of Independent Disks) drives or the like. It is noted that there could be multiple services, such as a plurality of databases containing information about device drivers. There could be one database, or separate databases for different manufacturers, or for different types of devices, for example. Access to the service 220 could take the form of an API provided by an application running on the client machine, an application making a call over a distributed programming model, such as DCOM, a web service call such as those provided by the MICROSOFT .NET FRAMEWORK, or the like. Such a service could match hardware IDs or other identifying properties of devices on a client with device drivers from the manufacturer, or from third party providers. A database could store device drivers internally, elsewhere on the local area network, or point to locations on other networks or on the Internet.

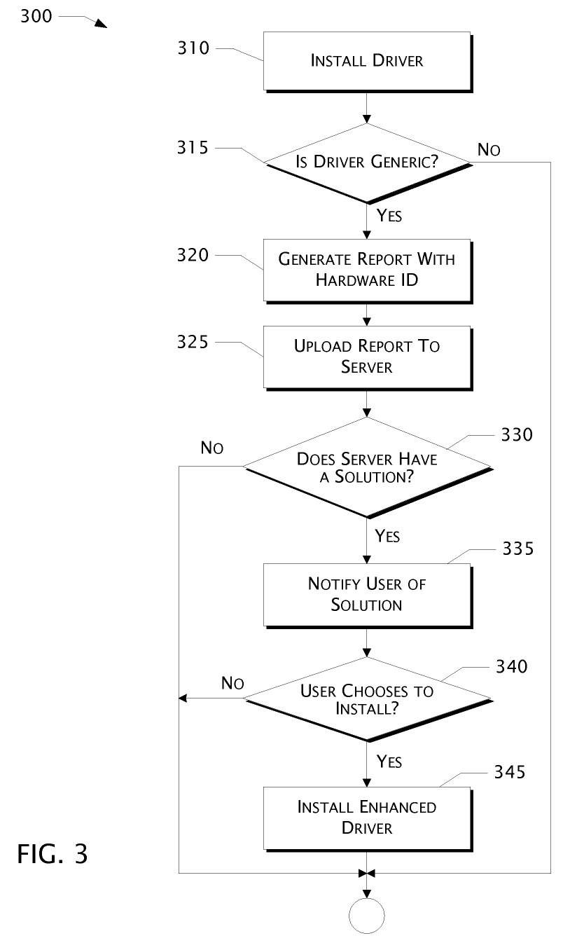

FIG. 3 is a flowchart of an exemplary implementation 300 for notifying a computer user that a generic device driver is in use and that an enhanced driver is available. In the following discussion, continuing reference may be made to elements and/or reference numerals contained in previous figures.

The process begins with installing a device driver at block 310. If the driver is not a generic driver (“No” branch, block 315), no further action is necessary, and the process terminates at block 350. The testing whether a driver is generic (block 315) may be done in many ways. For example, a driver could have a bit or some other attribute which may indicate that it is generic. In an alternative implementation there may be a file that describes the driver which includes information on whether or not it is generic. Yet another implementation could have a database of generic drivers which could be searched for the driver in question. If the driver is generic (“Yes” branch, block 315), a report is generated at block 320 containing a hardware ID which will identify the device. The report is uploaded to a server at block 325, where a check is done (block 330) to see if a solution, an enhanced driver for example, is available. If no solution is available (“No” branch, block 330), then the process terminates at block 350. If, however, a solution is available (“Yes” branch, block 330), the user is notified of the solution at block 335. The process terminates at block 350 if the user chooses not to install the new driver (“No” branch, bloc, 340). If the user chooses to install the new driver (“Yes” branch, block 340), the better driver is installed at block 345, and the process terminates at block 350.

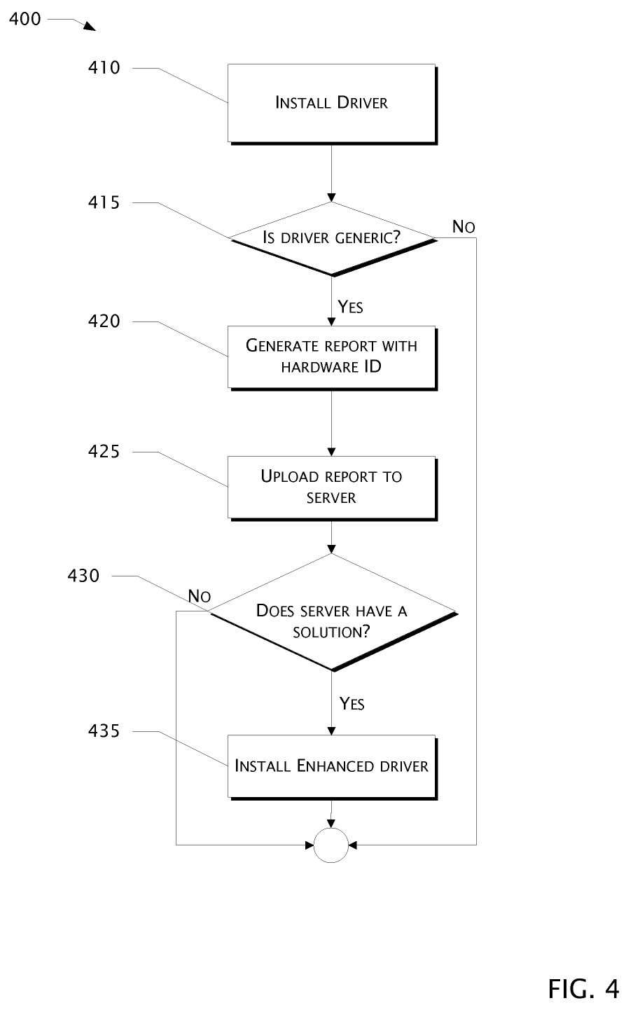

FIG. 4 is a flowchart of an exemplary implementation 400 for automatically replacing a generic device driver with an enhanced driver. The process starts at block 410 with the installing of a device driver. If the driver is not a generic driver in block 415 (“No” branch), no further action is necessary, and the process will finish at block 440. The testing at block 415 of whether a driver is generic may be done in many ways. For example, a driver could have a bit which may indicate that it is generic. In an alternative implementation, there could be a database of generic drivers which could be searched for the driver in question. Yet another implementation may have a file that describes the driver which includes information on whether or not it is generic. If the driver is generic at block 415 (“Yes” branch), a report is generated at block 420 containing a hardware ID which will identify the device. The report is uploaded to a server in block 425, where a check block 430 to see if a solution, an enhanced driver for example, is available. If so, the better driver may be installed in block 435, and the process finishes at block 440.

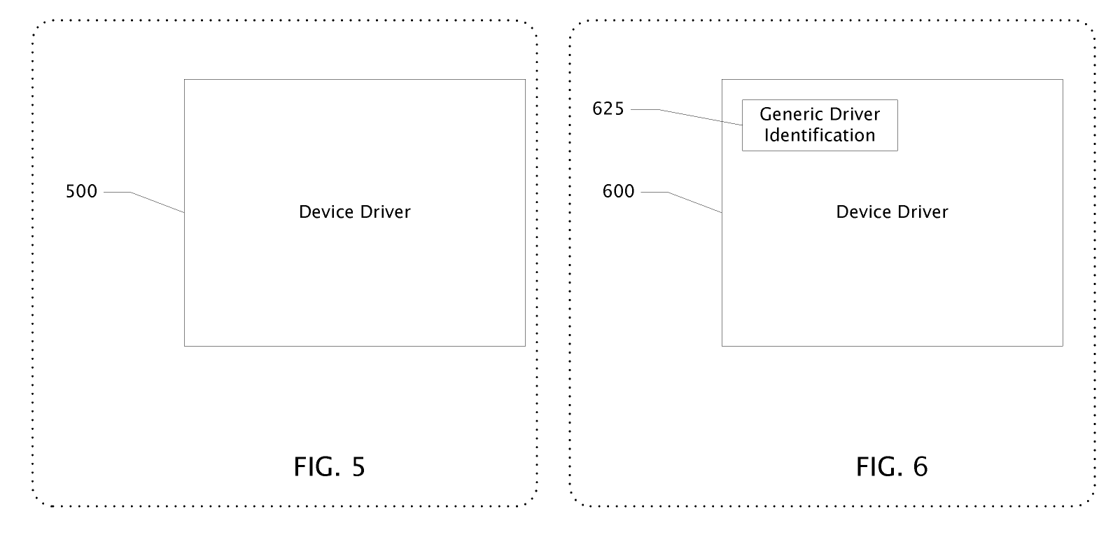

FIG. 5 is a block diagram of a device driver, block 500. Such a device driver is used for many different types of devices, including common devices such as display adapters, keyboards, mice, speakers, USB ports, printers, mass storage devices, and the like, as well as less common components such as lab equipment, speech synthesizers, and any other devices that a user wishes to attach to a computer.

FIG. 6 is a block diagram of a device driver, block 600, with a way, block 625, to indicate that it is a generic driver. This indication could be a bit, a byte, an API for which the driver responds, the name of the file, or any other way of identifying a driver as being generic.

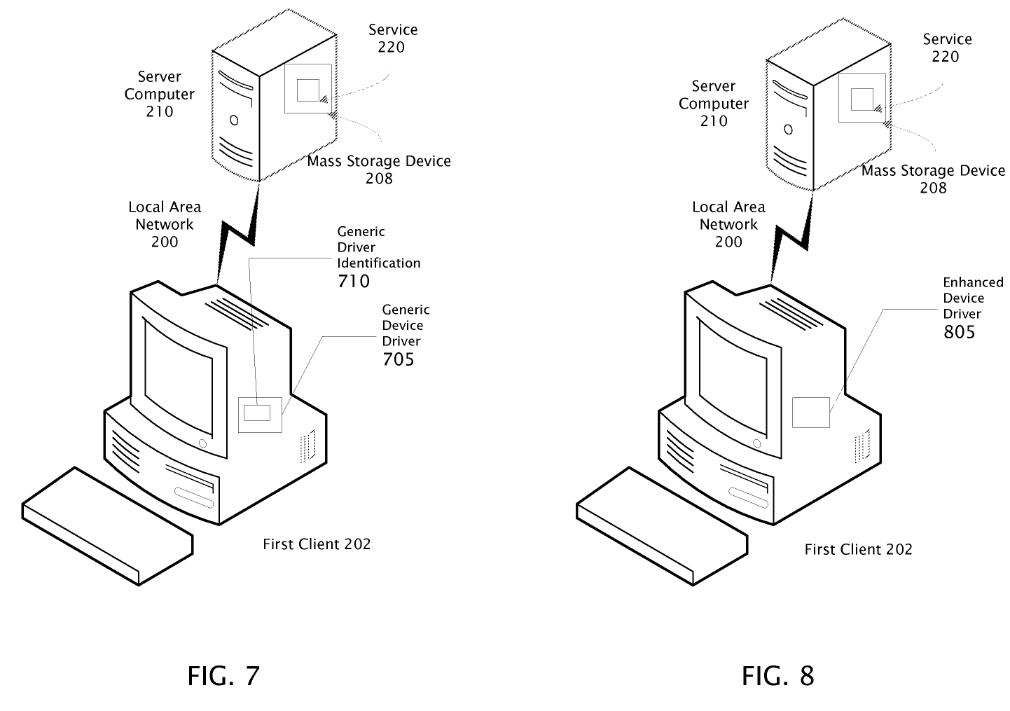

FIG. 7 is a block diagram of exemplary computer first client 202 with a generic device driver 705. Generic device driver 705 has an indicator that shows it is generic 710. First client 202 has access to a process for replacing a generic device driver with an enhanced driver, service 220. This service is disposed on mass storage device 208 on server computer 210. First client 202 is coupled to server computer 210 via a local area network 200.

After the service 220 has been called, and the generic driver has been replaced with an enhanced driver, we come to FIG. 8.

FIG. 8 is a block diagram of exemplary computer first client 202 with an enhanced device driver 805 after being updated by a process for replacing a generic device driver with an enhanced driver, provided by service 220 on server computer 210 over local area network 200.

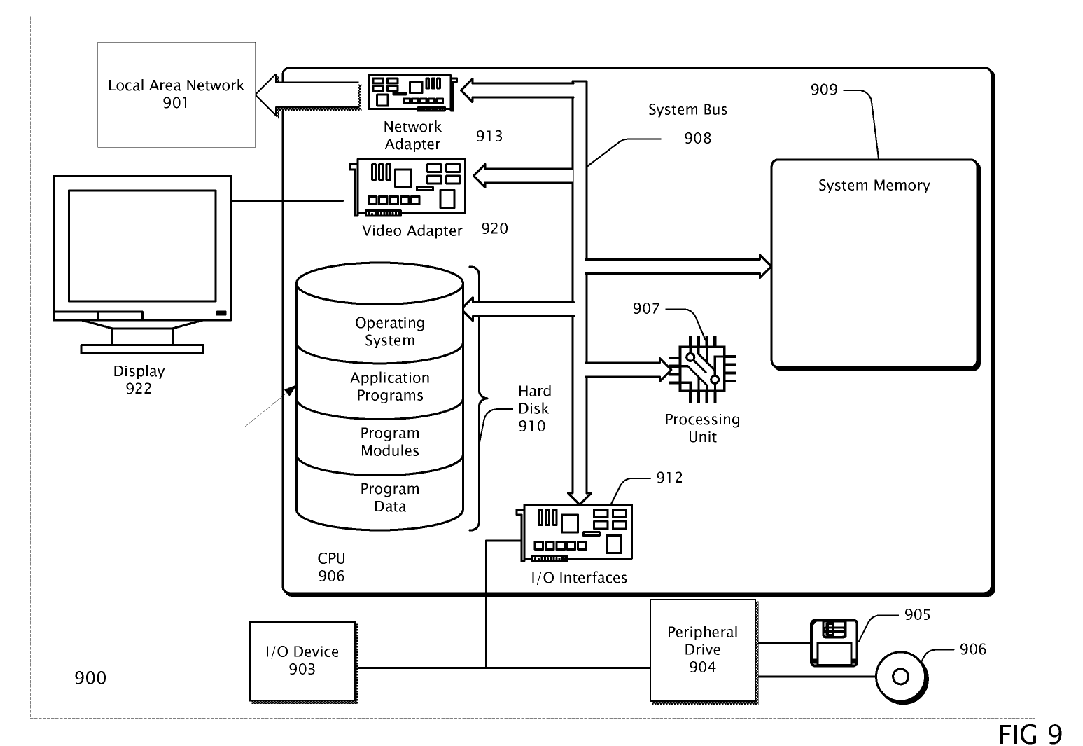

FIG. 9 is a block diagram which illustrates an exemplary computing environment in which the process for replacing a generic device driver with an enhanced driver may be implemented.

The exemplary computing environment 900 is only one example of a computing system and is not intended to limit the examples described in this application to this particular computing environment.

A peripheral drive 904 may accept a computer readable media 905, 906 that includes a copy of the method to suppress dialog boxes from background tabs. The peripheral drive may be coupled to an I/O interface 912 along with an I/O device 903.

The I/O interface 912 may be coupled to a bus structure 908, which also may couple to a hard disk 910, a processor 907, system memory 909, a video adapter 920 and a network adapter 913.

Video adapter 920 typically couples a display 922 to the CPU 906. Network adapter 913 typically couples a local area network 901 to the CPU 906.

For example the computer 301 can be implemented with numerous other general purpose or special purpose computing system configurations. Examples of well known computing systems, may include, but are not limited to, personal computers, hand-held or laptop devices, microprocessor-based systems, multiprocessor systems, set top boxes, gaming consoles, consumer electronics, cellular telephones, PDAs, and the like.

The computer 900 includes a general-purpose computing system in the form of a CPU 906, display 922, I/O device 903, and peripheral drive 904. The CPU 906 can include one or more processors 907 (including CPUs, GPUs, microprocessors and the like), a conventional system memory 909, and a conventional system bus 908 that couples the various system components. Processor 907 processes various computer executable instructions, including those to control the operation of computer 900 and allows communication with other electronic and computing devices (not shown). The system bus 908 represents any number of several types of bus structures, including a memory bus or memory controller, a peripheral bus, an accelerated graphics port, and a processor or local bus using any of a variety of bus architectures.

The system memory 909 may include computer-readable media in the form of volatile memory, such as random access memory (RAM), and/or non-volatile memory, such as read only memory (ROM). A basic input/output system (BIOS) is typically stored in ROM. RAM typically contains data and/or program modules that are immediately accessible to and/or presently operated on by one or more of the processors 907. Computing device 900 may include other removable/non removable, volatile/non-volatile computer storage media.

A hard disk drive 910 is also a type of computer readable media that may read from and write to a non-removable, non-volatile magnetic media (not shown). Such a hard disk drive may include a magnetic disk drive which reads from and writes to a removable, non volatile magnetic disk (e.g., a “floppy disk”) 905, or an optical disk drive that reads from and/or writes to a removable, non-volatile optical disk such as a CD ROM, DVD, or the like. In this example, the hard disk drive 910, and disk drive 904 are each connected to the system bus 908 by one or more data media interfaces 912. The disk drives and associated computer readable media provide non volatile storage of computer readable instructions, data structures, program modules, and other data for computing device 900.

Mass storage devices (or peripheral drive) 904 are also a type of computer readable media that may be coupled to the computing device or incorporated into the computing device by coupling to the bus 908. Such peripheral drive 904 may include a magnetic disk drive which reads from and writes to a removable, non volatile magnetic disk (e.g., a “floppy disk”) 905, or an optical disk drive that reads from and/or writes to a removable, non-volatile optical disk such as a CD ROM 906 or the like. Computer readable media (“CRM”) 905, 906 typically embody computer readable instructions, data structures, program modules and the like supplied on floppy disks, CDs, portable memory sticks and the like. Such CRM may be used to produce an initialization disk.

Any number of program modules or processes can be stored on the hard disk 910, or peripheral drive 904, including by way of example, backup files, an operating system, one or more application programs, other program modules, and program data. Each of such operating system, application programs, other program modules and program data (or some combination thereof) may include an implementation of the systems and methods described herein.

A display device 922 can be connected to the system bus 908 via an interface, such as a video adapter 920. A user can interface with the CPU 906 via any number of different input devices 903 such as a keyboard, pointing device, joystick, game pad, serial port, and/or the like. These and other input devices are connected to the processors 907 via input/output interfaces 912 that are coupled to the system bus 908, but may be connected by other interface and bus structures, such as a parallel port, game port, and/or a universal serial bus (USB).

Computer 900 can operate in a networked environment using connections to one or more remote computers through one or more local area networks (LANs), wide area networks (WANs) and the like. The computer 900 is connected to a network 901 via a network adapter 913 or alternatively by a modem, DSL, ISDN interface or the like.

1. A method to replace a generic device driver with an enhanced device driver comprising:
determining that a driver for a device is a generic driver;
determining one or more identifying properties of the device;
reporting one or more of the determined identifying properties of the device to a service;
receiving information about one or more enhanced device drivers from the service;
selecting an enhanced device driver to use;
obtaining the selected enhanced device driver; and
installing the selected enhanced device driver.

2. The method of claim 1 where the service is provided by a device on the Internet.

3. The method of claim 1 wherein the service is executed on a server on a local area network.

4. The method to replace a generic device driver with an enhanced device driver of claim 1 where the service is provided by a peer computer coupled via a network to a computer receiving the enhanced device driver.

5. The method of claim 1, wherein the selecting step further comprises selecting an enhanced driver when the enhanced driver is the only driver available for selection.

6. The method of claim 1 wherein the selecting an enhanced device driver to use step comprises:
collecting configuration information about an operating environment the device is part of; and
determining an optimal enhanced device driver based on the collected configuration information.

7. The method of claim 1 wherein the identifying properties include one or more identifying properties of compatible devices.

8. One or more computer readable media with instructions thereon that, when executed, perform method to replace a generic device driver disposed on a computer with an enhanced device driver comprising:
determining that a driver for a device is a generic driver;
determining one or more identifying properties of the device;
reporting one or more of the determined identifying properties of the device to a service;
receiving information about one or more enhanced device drivers from the service;
selecting an enhanced device driver to use;
obtaining the selected enhanced device driver; and
installing the selected enhanced device driver.

9. The one or more computer readable media of claim 8 wherein the service is provided by a device on the Internet.

10. The one or more computer readable media of claim 8 wherein the service is executed on a server on a local area network.

11. The one or more computer readable media of claim 8 wherein the service is provided by a peer computer coupled via a network to a computer receiving the enhanced device driver.

12. The one or more computer readable media of claim 8 wherein the selecting an enhanced device driver to use comprises:
collecting configuration information about an operating environment the device is part of; and
determining an optimal enhanced device driver based on the collected configuration information.

13. The one or more computer readable media of claim 8 wherein the selecting an enhanced device driver to use further comprises selecting an enhanced driver when the enhanced driver is the only driver available for selection.

14. A method of identifying that a device driver is generic, comprising:
determining that the device driver is generic; and
providing a value indicating that the device driver is generic.

15. The method of claim 14 wherein the determining comprises examining the value of one or more bits in the header of the device driver.

16. The method of claim 14 wherein the determining step comprises examining the value of one or more bits within the device driver.

17. The method of claim 14 wherein the determining step comprises performing a database lookup of the device driver file name.

18. The method of claim 14 wherein the determining step comprises:
obtaining identifying data from the device driver; and
performing an database lookup of all or part of the identifying data.

19. The method of claim 14 wherein the determining step comprises examining a plurality of bits in a file associated with the device driver.

20. The method of claim 14 wherein the determining step comprises:
calling an API provided by the device driver which provides one or more return values; and
examining one or more of the returned return values.
